(19) United States
(12) Patent Application Publication
(10) Pub. No.: US 2024/0043705 A1
(43) Pub. Date: Feb. 8, 2024

(54) MODIFIED POLYCARBODIIMIDE COMPOUND, COATING COMPOSITION AND COATED ARTICLE

(71) Applicant: GUANGDONG HUARUN PAINTS CO., LTD, Foshan City (CN)

(72) Inventors: Hongbin Chen, Foshan City (CN); Jun Zhang, Foshan City (CN); Weichang Du, Foshan City (CN)

(21) Appl. No.: 18/042,330

(22) PCT Filed: Aug. 20, 2021
(86) PCT No.: PCT/CN2021/113912

§ 371 Date: Feb. 21, 2023

(30) Foreign Application Priority Data
Aug. 21, 2020 (CN) 202010847974.9

(51) Int. Cl. C09D 7/65; C08G 73/02; C09D 133/04; C09D 175/04; C09D 5/02

(52) U.S. Cl. CPC C09D 7/65; C08G 73/02; C09D 133/04; C09D 175/04; C09D 5/022

(57) ABSTRACT

The present application relates to a modified polycarbodiimide compound, a coating composition and a coated article. The modified polycarbodiimide compound of the present application comprises a polymer backbone containing at least one —N═C═N— structural unit and at least one

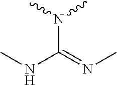

structural unit, wherein the

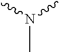

represents aza-heterocyclic ring attached to the polymer backbone, and the aza-heterocyclic ring is fused or chemically bonded with optionally substituted or optionally aza-benzene ring. Compared with unmodified polycarbodiimide compound, the modified polycarbodiimide compound described herein can significantly improve the chemical resistance of the cured coating.

### TECHNICAL FIELD

The present application relates to a modified polycarbodiimide compound, a coating composition comprising the modified polycarbodiimide compound, and a coated article comprising a cured coating formed by the coating composition.

### BACKGROUND

In the coating industry, crosslinking agents are widely used to accelerate the crosslinking of polymers and improve the hardness, chemical resistance and the like of film. At present, a crosslinking agent known to show excellent performance in coating formulations includes aziridine. However, aziridine as crosslinking agent is a sensitizing and toxic substance.

With people's increasing attention to health and environmental protection, it is increasingly desirable to reduce or even avoid the use of sensitizing substances in coatings. Due to the advantages including non-toxicity, VOC free and high adhesion, polycarbodiimide has attracted extensive attention. However, compared with conventional crosslinking agents such as aziridine and silane compounds, the properties of film obtained by using polycarbodiimide, especially chemical resistance (such as water resistance), are significantly poor. Some researchers try to improve the film properties by modifying carbodiimide compounds. However, most of these attempts involve complex modification processes, and have low output and difficulty to control the product quality and a narrow scope of applications, so they have high cost, which greatly limits scope and prospect of applications of polycarbodiimide compounds in the market.

### SUMMARY

Therefore, there is still a need in the coating industry for a low-cost, easy to operate, safe and non-toxic crosslinking agent that contains less or even no sensitizing substances and is capable of forming a dense film having excellent chemical resistance.

The above objective can be achieved by the modified polycarbodiimide compound described herein.

A first aspect of the present application provides a modified polycarbodiimide compound, comprising a polymer backbone containing at least one —N═C═N— structural unit and at least one

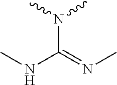

structural unit, wherein the

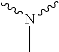

represents aza-heterocyclic ring attached to the polymer backbone, and the aza-heterocyclic ring is fused or chemically bonded with optionally substituted or optionally aza-benzene ring.

A second aspect of the present application provides a coating composition, comprising component A) and component B), wherein the component A) comprises at least one film-forming resin, at least one co-solvent and at least one optional additive; the component B) comprising at least one crosslinking agent, wherein the at least one crosslinking agent comprises the modified polycarbodiimide compound described herein.

A third aspect of the present application provides a coated article, comprising a substrate; and a cured coating formed by the coating composition described herein, coated on the substrate.

The present application also provides use of a modified polycarbodiimide compound described herein in a coating composition. The film formed by the coating composition has excellent chemical resistance (such as water resistance).

It has been found that the modified polycarbodiimide compound described herein can lead to the formation of a dense film after curing of coating composition comprising the modified polycarbodiimide compound, and improve chemical resistance, especially water resistance of the film. The modified polycarbodiimide compound has excellent stability. In addition, the modified polycarbodiimide compounds described herein are non-sensitizing substances and have low VOC. Therefore, the technical solutions of the application can also have the advantages of simple operation, safety, environmental protection, and low cost, etc.

By applying the modified polycarbodiimide compound or the coating composition described herein, the use of sensitizing substances can be reduced or even avoided, and meanwhile chemical resistance may be surprisingly improved.

The details of one or more embodiments of the application will be set forth in the description below. The other features, objectives, and advantages of what is described herein will become apparent.

### BRIEF DESCRIPTION OF DRAWINGS

FIG. 1 shows a comparison of an unmodified polycarbodiimide compound (PCDI) with a modified polycarbodiimide compound (PCDI #-C) according to an embodiment of the present application in Fourier Transform Infrared Spectroscopy (FT-IR).

FIG. 2 shows the Differential scanning calorimetry (DSC) curve of benzotriazole.

FIG. 3 shows the DSC curves of an unmodified polycarbodiimide compound (PCDI) and a modified polycarbodiimide compound (PCDI #-C) according to an embodiment.

FIG. 4 shows photos exhibiting water resistance of films that are prepared with an unmodified polycarbodiimide compound (PCDI), a modified polycarbodiimide compound (PCDI #-C) according to one embodiment and PCDI #-C after one-month heat storage.

### DETAILED DESCRIPTION

### Definition

As used herein, “a”, “an”, “the”, “at least one”, and “one or more” are used interchangeably. Thus, for example, a coating composition that comprises “an” additive can be interpreted to mean that the coating composition includes “one or more” additives. As used herein, the singular forms are intended to include the plural forms as well, unless the context clearly indicates otherwise.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned herein, as along as such components or steps do not affect the basic and novel characteristics, but it is also contemplated that the compositions or processes may consist essentially of, or consist of, the recited components or steps.

For the sake of brevity, only certain ranges are explicitly disclosed herein. However, it should be understood that any lower limit may be combined with any upper limit to recite a range not explicitly recited, as well as, any lower limit may be combined with any other lower limit to recite a range not explicitly recited, in the same way, any upper limit may be combined with any other upper limit to recite a range not explicitly recited.

Unless otherwise indicated, the recitations of numerical ranges by endpoints include all numbers subsumed within that range. For example, a range of from 1 to 5 includes 1, 1.5, 2, 2.75, 3, 3.80, 4, 5, etc. Furthermore, disclosure of a range includes disclosure of all subranges included within the broader range. For example, a range of from 1 to 5 discloses the subranges of from 1 to 4, from 1.5 to 4.5, from 1 to 2, etc. Thus, every point or individual value may serve as a lower or upper limit combined with any other point or individual value or any other lower or upper limit, to recite a range explicitly recited in the present application.

In the context of describing that a composition does not contain or is free of an ingredient, the phrases “does not contain” and “is free of” mean that the composition does not contain the ingredient intentionally added. Under the consideration of the complexity of components of a specific composition in the actual preparation process, the phrases “does not contain a certain component” and “is free of a certain component” can be understood to mean that the composition contains less than 1 wt. % (weight %) of the component, less than 0.5 wt. %, than 0.2 wt. %, and less than 0.1 wt. % of the component, relative to total weight of the composition.

The coating composition described herein may be mono-component or multi-component. In the context of a “multi-component” coating composition, the term “multi-component” means that the coating composition includes two or more components stored or packaged separately and then mixed together before being applied to the substrate. In some embodiments, the multi-component coating composition consists of two components (including film-forming component and crosslinking agent component), thus may also be referred to as a two-component coating composition.

The coating composition described herein may be an “aqueous” coating composition. The term “aqueous” means that the solvent or carrier fluid of the coating composition mainly or primarily contains water. For example, in some embodiments, the solvent or carrier fluid comprises at least about 50 wt. %, at least about 60 wt. %, at least 70 wt. %, and up to about 100 wt. % of water based on the total weight of the solvent or carrier fluid. For example, based on the total weight of the solvent or carrier fluid, the solvent or carrier fluid contains about 80 wt. %, about 85 wt. %, or about 90 wt. % of water.

“Sensitizing substance” as used herein refers to a substance that may cause sensitization through skin contact. In particular, “sensitizing substance” is a substance with “sensitizing effect” clearly recorded in its chemical material safety data sheet (MSDS). Examples of sensitizing substance include aziridine and substances with similar structures.

The term “dispersion” herein conforms to the definition in the IUPAC Compendium of Chemical Terminology (2007), which defines a dispersion to be a material comprising more than one phase, where at least one of the phases consists of finely divided phase domains, often in the colloidal size range, distributed throughout a continuous phase domain.

As used herein, the term “aqueous dispersion comprising polymer particles” refers to a stable dispersion of synthetic resin (i.e., polymer) in the form of particles in an aqueous liquid medium, optionally with the aid of suitable dispersion aids such as surfactants, co-solvents. Therefore, in the present application, when used for polymers, unless otherwise stated, the terms “aqueous latex” and “aqueous dispersion” may be used alternately. Aqueous latex may be prepared by methods known in the field, for example, by emulsion polymerization process known by technicians in this field. Suitable emulsion polymerization processes are well known to a person skilled in the art, and generally include the steps of: dispersing and emulsifying polymerizable monomers in water with the aid of, as appropriate, at least one emulsifier and/or at least one dispersion stabilizer under agitation; and initiating polymerization of the monomers, e.g., by adding an initiator. In the present disclosure, the polymeric particles can be modified by, for example, incorporating therein some organic functional groups including, but not limited thereto, carboxyl, hydroxyl, amino, isocyanate, sulphonic group or the like, whereby the aqueous latex can be obtained with desirable properties such as dispersability. Therefore, as used herein, the term “aqueous latex” or “aqueous dispersion” as used herein encompasses not only a dispersion or latex of unmodified polymeric particles in an aqueous medium, but also a dispersion or latex of organo-functional modified polymeric particles in an aqueous medium.

The term “alkyl” as used herein means a straight or branched chain hydrocarbon containing from 1 to 10 carbon atoms, and preferably 1, 2, 3, 4, 5, or 6 carbons. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl. Each of the carbon atoms of the alkyl group is substituted with 0, 1, or 2 substituents selected from acyl, acyloxy, alkoxy, alkoxyalkoxy, alkoxyalkyl, alkoxycarbonyl, alkoxyimino, alkoxysulfonyl, alkylcarbonyl, alkylsulfonyl, amido, carboxy, cyano, cycloalkyl, fluoroalkoxy, formyl, haloalkoxy, haloalkyl, halogen, hydroxy, hydroxyalkyl, mercapto, nitro, oxo and alkylthio.

The term “alkylamino” as used herein means an alkyl group, as defined herein, appended to the parent molecular moiety through a NH group. Representative examples of alkylamino include, but are not limited to, methylamino, ethylamino, isopropylamino, and butylamino.

The term “alkylcarbonyl” as used herein means an alkyl group, as defined herein, appended to the parent molecular moiety through a carbonyl group. Representative examples of alkylcarbonyl include, but are not limited to, methylcarbonyl, ethylcarbonyl, isopropylcarbonyl, n-propylcarbonyl, and the like.

The term “alkylsulfonyl” as used herein means an alkyl group, as defined herein, appended to the parent molecular moiety through a sulfonyl group. Representative examples of alkylsulfonyl include, but are not limited to, methylsulfonyl and ethylsulfonyl.

The term “alkoxy” as used herein means an alkyl group, as defined herein, appended to the parent molecular moiety through an oxygen atom. Representative examples of alkoxy include, but are not limited to, methoxy, ethoxy, propoxy, 2-propoxy, butoxy, tert-butoxy, pentyloxy, and hexyloxy.

The term “alkoxycarbonyl” as used herein means an alkoxy group, as defined herein, appended to the parent molecular moiety through a carbonyl group, as defined herein. Representative examples of alkoxycarbonyl include, but are not limited to, methoxycarbonyl, ethoxycarbonyl, isopropoxycarbonyl, and tert-butoxy carbonyl.

The term “alkoxyalkyl” as used herein means an alkoxy group, as defined herein, appended to the parent molecular moiety through an alkyl group, as defined herein. Representative examples of alkoxyalkyl include, but are not limited to, tert-butoxymethyl, 2-ethoxyethyl, 2-methoxyethyl, and methoxymethyl.

The term “cycloalkyl” as used herein means a saturated cyclic hydrocarbon group containing from 3 to 8 carbons. Examples of cycloalkyl include cyclopropyl, cyclobutyl, cyclopentyl, cyclohexyl, cycloheptyl, and cyclooctyl. Each of the carbon atoms of the cycloalkyl groups is substituted with 0, 1, or 2 substituents selected from acyl, acyloxy, alkenyl, alkoxy, alkoxyalkoxy, alkoxyalkyl, alkoxycarbonyl, alkoxyimino, alkoxysulfonyl, alkyl, alkylcarbonyl, alkylsulfonyl, alkynyl, amido, carboxy, cyano, cycloalkyl, fluoroalkoxy, formyl, haloalkoxy, haloalkyl, halogen, hydroxy, hydroxyalkyl, mercapto, nitro, and alkylthio.

The term “acyl” as used herein means an alkyl group, as defined herein, appended to the parent molecular moiety through a carbonyl group, as defined herein. Representative examples of acyl include, but are not limited to, acetyl, 1-oxopropyl, 2,2-dimethyl-1-oxopropyl, 1-oxobutyl, and 1-oxopentyl.

The term “halo” or “halogen” as used herein means Cl, Br, I, or F.

The term “haloalkyl” as used herein means at least one halogen, as defined herein, appended to the parent molecular moiety through an alkyl group, as defined herein. Representative examples of haloalkyl include, but are not limited to, chloromethyl, 2-fluoroethyl, trifluoromethyl, pentafluoroethyl, and 2-chloro-3-fluoropentyl.

The term “haloalkoxy” as used herein means at least one halogen, as defined herein, appended to the parent molecular moiety through an alkoxy, as defined herein. Representative examples of haloalkoxy include, but are not limited to, 2-fluoroethoxy, trifluoromethoxy, and pentafluoroethoxy.

The terms “aryl” and “aromatic group” as used herein mean optionally substituted phenyl, a bicyclic aryl, or a tricyclic aryl. The bicyclic aryl is attached to the parent molecular moiety through any carbon atom contained within the bicyclic aryl. Representative examples of the bicyclic aryl include, but are not limited to, dihydroindenyl, indenyl, naphthyl, dihydronaphthalenyl, and tetrahydronaphthalenyl. The tricyclic aryl is a tricyclic aryl ring system such as anthracene or phenanthrene, a bicyclic aryl fused to a cycloalkyl, a bicyclic aryl fused to a cycloalkenyl, or a bicyclic aryl fused to a phenyl. The tricyclic aryl is attached to the parent molecular moiety through any carbon atom contained within the tricyclic aryl. Representative examples of tricyclic aryl ring include, but are not limited to, anthracenyl, phenanthrenyl, azulenyl, dihydroanthracenyl, fluorenyl, and tetrahydrophenanthrenyl.

The carbon atoms of the aryl groups may be optionally substituted with one or more substituents independently selected from acyl, acyloxy, alkenyl, alkoxy, alkoxyalkoxy, alkoxyalkyl, alkoxycarbonyl, alkoxyimino, alkoxysulfonyl, alkyl, alkylcarbonyl, alkylsulfonyl, alkynyl, amido, carboxy, cyano, cycloalkyl, fluoroalkoxy, formyl, haloalkoxy, haloalkyl, halogen, hydroxy, hydroxyalkyl, mercapto, nitro, and alkylthio. Where the aryl group is a phenyl group, the number of substituents is 0, 1, 2, 3, 4, or 5. Where the aryl group is a bicyclic aryl, the number of substituents is 0, 1, 2, 3, 4, 5, 6, 7, 8, or 9. Where the aryl group is a tricyclic aryl, the number of substituents is 0, 1, 2, 3, 4, 5, 6, 7, 8, or 9.

The term “arylalkyl” as used herein means an aryl group, as defined herein, appended to the parent molecular moiety through an alkyl group, as defined herein. Representative examples of arylalkyl include, but are not limited to, benzyl, 2-phenylethyl and 3-phenylpropyl.

The term “heteroaryl” as used herein may be monocyclic or bicyclic. The carbon atoms of the heteroaryl group may be optionally substituted with one or more substituents independently selected from acyl, acyloxy, alkenyl, alkoxy, alkoxyalkoxy, alkoxyalkyl, alkoxycarbonyl, alkoxyimino, alkoxysulfonyl, alkyl, alkylcarbonyl, alkylsulfonyl, alkynyl, amido, carboxy, cyano, cycloalkyl, fluoroalkoxy, formyl, haloalkoxy, haloalkyl, halogen, hydroxy, hydroxyalkyl, mercapto, nitro, and alkylthio. Monocyclic heteroaryl or 5- or 6-membered heteroaryl rings are substituted with 0, 1, 2, 3, 4, or 5 substituents. Bicyclic heteroaryl or 8- to 12-membered bicyclic heteroaryl rings are substituted with 0, 1, 2, 3, 4, 5, 6, 7, 8, or 9 substituents. Heteroaryl groups of what is described herein may be present as tautomers.

Whenever a group is described as being “optionally substituted”, that group may be unsubstituted or substituted with one or more of the indicated substituents.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of what is disclosed herein.

According to the first aspect of the present disclosure, a modified polycarbodiimide compound is provided. The modified polycarbodiimide compound as described herein is modified with fused aza-heterocyclic compound or an aza-heterocyclic compound substituted with an aromatic group. The modified polycarbodiimide compound comprises a polymer backbone containing at least one —N═C═N— structural unit and at least one

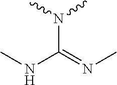

structural unit. The

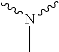

represents aza-heterocyclic ring attached to the polymer backbone, and the aza-heterocyclic ring is fused or chemically bonded with optionally substituted or optionally aza-benzene ring.

Wavy lines represent connections to other atoms on the ring. The wavy lines in

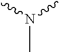

represent the connections between the nitrogen atom and other atoms in the aza-heterocyclic ring. The nitrogen atom and other atoms in the aza-heterocyclic ring form the aza-heterocyclic ring through the connections shown. That is, the nitrogen atom is an atom in the aza-heterocyclic ring, and the aza-heterocyclic ring is connected with the polymer backbone through the nitrogen atom.

Therefore, in an exemplary embodiment, the structural unit

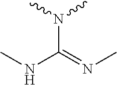

may also be represented as

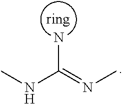

In this structural unit, the aza-heterocyclic ring in or are connected to the polymer backbone via the chemical bond on the N atom.

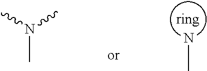

The modified polycarbodiimide compound herein may have a structural unit comprising at least one —N═C═N— functional group in the polymer backbone. The at least one —N═C═N— functional group can react with reactive groups such as carboxyl, amino, hydroxyl and sulfhydryl in resin components. In particular, the at least one —N═C═N— functional group can react with the carboxyl group in the resin component.

In some embodiments, the modified polycarbodiimide compound has at least two carbodiimide groups (—N═C═N—) or carbodiimide-derived moieties. In some embodiments, the modified polycarbodiimide compound has at least three carbodiimide groups. For example, in some exemplary embodiments, the modified polycarbodiimide compound has 3 to 7 carbodiimide groups. The modified polycarbodiimide compound may include modified aliphatic carbodiimide compounds, modified alicyclic carbodiimide compounds, or modified aromatic carbodiimide compounds.

It can be seen that the modified polycarbodiimide compound in this application contains at least one —N═C═N— structural unit and at least one

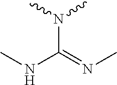

structural unit in the polymer backbone. It has been found that by adopting this combination of specific structural units, the modified polycarbodiimide compound can have excellent crosslinking performance and improve the chemical resistance of the cured coating.

In some embodiments, molar ratio of the at least one —N═C═N— structural unit and at least one

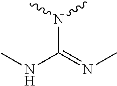

structural unit in the polymer backbone is in the range of from about 100:80 to 100:10. Preferably, the molar ratio of the at least one —N═C═N— structural unit and at least one

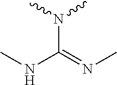

structural unit is about 100:15 or less, about 100:20 or less, and about 100:25 or less. The molar ratio of the at least one —N═C═N— structural unit and at least one

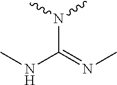

structural unit may be about 100:70 or more, about 100:65 or more, and about 100:60 or more. For example, the molar ratio of the at least one —N═C═N— structural unit and at least one

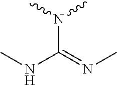

structural unit may be about 100:30, 100:40 or 100:50. The inventors have surprisingly found that by controlling the relative content of at least one —N═C═N— structural unit and at least one

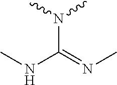

structural unit in the modified polycarbodiimide compound, chemical resistance of the cured coating can be further improved.

In some embodiments, the modified polycarbodiimide compound has a number average molecular weight of from about 1500 to 5000 g/mol. In some embodiments, the number average molecular weight of the modified polycarbodiimide compound is about 1800 g/mol or more, and in one embodiment about 1900 g/mol or more. In some embodiments, the number average molecular weight of the modified polycarbodiimide compound is about 4500 g/mol or less, and in one embodiment about 4000 g/mol or less. For example, the number average molecular weight of the modified polycarbodiimide compound may be about 2000 g/mol, about 2100 g/mol, about 2200 g/mol, about 2300 g/mol, about 2500 g/mol, about 3000 g/mol, or about 3500 g/mol. As an example, the number average molecular weight of the modified polycarbodiimide compound can be adjusted by changing the type of polycarbodiimide raw material and the relative amounts of modifier and polycarbodiimide raw material. Other technical means that are easily envisaged by those skilled in the art may also be used to adjust the number average molecular weight of the compound.

In the at least one

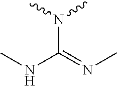

structural unit of the modified polycarbodiimide compound, the aza-heterocyclic ring connected to the backbone of the polymer can be a fused aza-heterocyclic ring or an aza-heterocyclic ring substituted with an aromatic group. In some embodiments, in the modified polycarbodiimide compound, the at least one

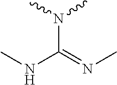

structural unit may be selected from one or more of

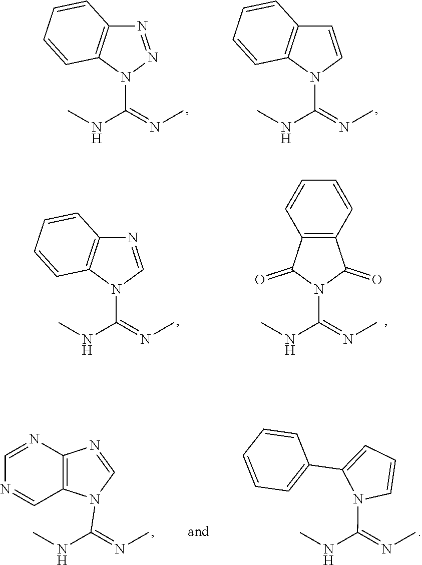

In some embodiments, the at least one

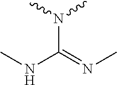

structural unit may be selected from one or more of

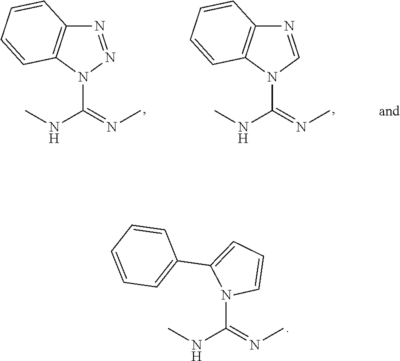

In the at least one

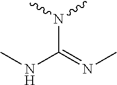

structural unit, the at least one benzene ring may be optionally substituted or optionally comprise nitrogen (optionally aza-benzene ring). In some embodiments, the at least one benzene ring is unsubstituted. In some embodiments, the at least one benzene ring is unaze- (does not comprise nitrogen). In some embodiments, the at least one benzene ring is unsubstituted and unaze-.

In some other embodiments, the at least one benzene ring is substituted. For example, the at least one benzene ring is substituted with one or more of —OH, alkyl, alkylamino, alkylcarbonyl, alkylsulfonyl, alkoxy, alkoxycarbonyl, alkoxyalkyl, alkoxyimino, alkoxysulfonyl, alkylthio, cycloalkyl, acyl, halogen, haloalkyl, haloalkoxy, hydroxyalkoxy, aryl, arylalkyl and heteroaryl. In some embodiments, the at least one benzene ring may be substituted with one or more of alkyl, alkyl amino, cycloalkyl, halogen, haloalkyl, haloalkoxy, aryl, arylalkyl and heteroaryl.

In some embodiments, the at least one benzene ring may contain one or more nitrogen atoms (may be one or more aza-). In one embodiment, the at least one benzene ring contains one or two nitrogen atoms (is one or two aza-).

In some embodiments, the modified polycarbodiimide compound may be prepared by reacting at least one polycarbodiimide compound with at least one fused aza-heterocyclic compound or at least one aza-heterocyclic compound substituted with an aromatic group, wherein the at least one fused aza-heterocyclic compound or the at least one aza-heterocyclic compound substituted with at least one aromatic group has a ring containing at least one —NH— bond. Thus, a process for the preparation of the modified polycarbodiimide compound is also provided herein, comprising reacting a polycarbodiimide compound with at least one fused aza-heterocyclic compound or at least one aza-heterocyclic compound substituted with at least one aromatic group, wherein the at least one fused aza-heterocyclic compound or the at least one aza-heterocyclic compound substituted with at least one aromatic group has a ring containing at least one —NH— bond.

It is known in the art that the at least one fused aza-heterocyclic compound and the at least one aza-heterocyclic compound substituted with at least one aromatic group themselves have a special π electron aromatic ring. In this disclosure, the at least one fused aza-heterocyclic compound and the at least one aza-heterocyclic compound substituted with at least one aromatic group that are useful for the preparation of the modified polycarbodiimide compound also have a ring containing at least one —NH— bond, in addition to the special π electron aromatic ring. The at least one fused aza-heterocyclic compound or the at least one aza-heterocyclic compound substituted with at least one aromatic group may also be an amine compound containing at least one benzene ring.

Without wishing to be bound by theory, it is believed that the at least one —NH— bond in the at least one fused aza-heterocyclic compound or the at least one aza-heterocyclic compound substituted with at least one aromatic group can react with at least one —N═C═N— in the polycarbodiimide compound. As a result, the aromatic group and aza-heterocyclic ring are attached to the polymer backbone. After the formation of a coating by curing a coating composition comprising the modified polycarbodiimide compound and a film-forming resin or emulsion, the at least one fused aza-heterocyclic group or the at least one aza-heterocyclic group substituted with at least one aromatic group may be contained in film via chemical bond, which improves the hydrophobicity and denseness of the film, thereby improving the resistance of the film.

In some embodiments, the at least one fused aza-heterocyclic compound or the at least one aza-heterocyclic compound substituted with at least one aromatic group has a structure with five-membered aza-heterocyclic ring or a structure with six-membered aza-heterocyclic ring. In other words, in the modified polycarbodiimide compound, the aza-heterocyclic ring in

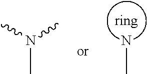

may be a five-membered aza-heterocyclic ring or a six-membered aza-heterocyclic ring.

In some embodiments, the at least one fused aza-heterocyclic compound has a structure with five-membered aza-heterocyclic ring. The aza-heterocyclic structure may have one or more nitrogen atoms. In some embodiments, the aza-heterocyclic ring in

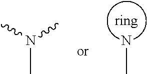

is a five-membered aza-heterocyclic ring. The nitrogen atom in the ring attached to the polymer backbone are in five-membered aza-heterocyclic ring. In one embodiment, the aza-heterocyclic ring may have 2 to 3 nitrogen atoms, and in one embodiment, 3 nitrogen atoms.

The five-membered aza-heterocyclic ring or the six-membered aza-heterocyclic ring may be fused or chemically bonded with at least one benzene ring. In the fused aza-heterocyclic compound and the aza-heterocyclic compound substituted with an aromatic group, the at least one benzene ring may be optionally substituted or optionally comprise nitrogen (optionally aza-benzene ring). In some embodiments, the at least one benzene ring is unsubstituted. In some embodiments, the benzene ring is unaze- (does not comprise nitrogen). In some embodiments, the at least one benzene ring is unsubstituted and unaze-.

In some other embodiments, in the at least one fused aza-heterocyclic compound and the at least one aza-heterocyclic compound substituted with at least one aromatic group, the at least one benzene ring is substituted. For example, the at least one benzene ring is substituted with one or more of —OH, alkyl, alkylamino, alkylcarbonyl, alkylsulfonyl, alkoxy, alkoxycarbonyl, alkoxyalkyl, alkoxyimino, alkoxysulfonyl, alkylthio, cycloalkyl, acyl, halogen, haloalkyl, haloalkoxy, hydroxyalkoxy, aryl, arylalkyl and heteroaryl. In some embodiments, the at least one benzene ring may be substituted with one or more of alkyl, alkyl amino, cycloalkyl, halogen, haloalkyl, haloalkoxy, aryl, arylalkyl and heteroaryl.

In some embodiments, in the at least one fused aza-heterocyclic compound and the at least one aza-heterocyclic compound substituted with at least one aromatic group, the at least one benzene ring may contain one or more nitrogen atoms (may be one or more aza-). In some embodiments, the at least one benzene ring contains one or two nitrogen atoms (is one or two aza-).

In the at least one fused aza-heterocyclic compound, the at least one aza-heterocyclic ring is fused with at least one benzene ring. In some embodiments, the at least one fused aza-heterocyclic compound may comprise one or more of

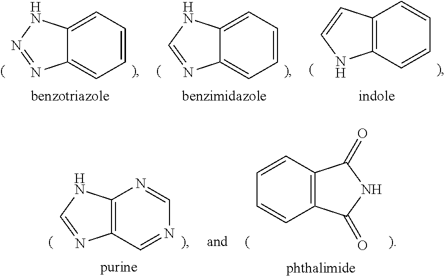

In one embodiment, the at least one fused aza-heterocyclic compound comprises one or any combination of benzotriazole, benzimidazole and indole. In one embodiment, the at least one fused aza-heterocyclic compound comprises benzotriazole and/or benzimidazole. Particularly, the at least one fused aza-heterocyclic compound comprises benzotriazole. The at least one benzene ring in the at least one fused aza-heterocyclic compound may be optionally substituted or optionally aza-. The embodiments of substituents are as described above.

In the at least one aza-heterocyclic compound substituted with at least one aromatic group, the at least one aza-heterocyclic ring may be chemically bonded with at least one aromatic group. The aromatic group may have one or more benzene ring structural moieties. In some embodiments, the at least one aza-heterocyclic compound substituted with at least one aromatic group may be an aza-heterocyclic compound substituted with a phenyl group. In some embodiments, the aza-heterocyclic compound substituted with an aromatic group may include one or more of 2-phenylimidazole

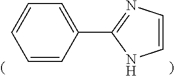 [SMILES: c1ccc(-c2ncc[nH]2)cc1]

and 2-phenyl-4-methylimidazole

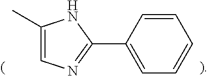

In the aza-heterocyclic compound substituted with an aromatic group, the at least one benzene ring may be optionally substituted or optionally aza-. The embodiments of substituent are as described above.

It should be noted that after the reaction of at least one polycarbodiimide compound with the at least one fused aza-heterocyclic compound and the at least one aza-heterocyclic compound substituted with at least one aromatic group, the resultant modified polycarbodiimide compound still contains at least one —N═C═N— group, so that it can still function as a cross-linking agent. Therefore, it may also be considered that the modified polycarbodiimide compound in this disclosure is partially modified.

Moreover, it has been found that chemical resistance of the cured coating may be further improved by adjusting the degree of modification or the relative amounts of the polycarbodiimide compound and the at least one fused aza-heterocyclic compound and the at least one aza-heterocyclic compound substituted with at least one aromatic group.

In some embodiments, the weight ratio of polycarbodiimide compound to the at least one fused aza-heterocyclic compound and the at least one aza-heterocyclic compound substituted with at least one aromatic group may be preferably about 100:3 or less, about 100:4 or less, and about 100:5 or less. The weight ratio of the polycarbodiimide compound to the at least one fused aza-heterocyclic compound and the at least one aza-heterocyclic compound substituted with at least one aromatic group may be about 100:20 or less, about 100:17 or less, and about 100:15 or less. For example, the weight ratio of the polycarbodiimide compound to the at least one fused aza-heterocyclic compound and the at least one aza-heterocyclic compound substituted with at least one aromatic group may be about 100:6, 100:8, 100:10, 100:12 or 100:14. These values are only exemplary. Those skilled in the art can reasonably understand that the weight ratio of the polycarbodiimide compound to the at least one fused aza-heterocyclic compound and the at least one aza-heterocyclic compound substituted with at least one aromatic group may also be any value between the above values. Moreover, the range defined by any of these values also belongs to the content disclosed herein.

It has been found that the modified polycarbodiimide compound described herein can improve the resistance of cured coating. The improvement of resistance may comprise the improvement of chemical resistance, such as at least one of alcohol resistance, acid resistance, water resistance and heat resistance, especially water resistance. By applying some embodiments described herein, the obtained film has comparable or even better resistance, and, in many embodiments, an improved hardness, compared with the film obtained by using a crosslinking agent (such as PCDI). Moreover, chemical resistance of the cured coating can be further improved by adjusting the degree of modification. In addition, in some embodiments, the modified polycarbodiimide compound also has excellent stability, still has good crosslinking effect after storage for a certain time, meanwhile the formed cured coating also has excellent stability in water resistance. These effects are unexpected to those skilled in the art.

A second aspect of the present application provides a coating composition, comprising component A) and component B), wherein the component A) comprises at least one film-forming resin, at least one co-solvent and at least one optional additive; the component B) comprising at least one crosslinking agent, wherein the at least one crosslinking agent comprises the modified polycarbodiimide compound described herein.

In some embodiments, based on the total weight of the coating composition, the modified polycarbodiimide compound may have an amount of about 0.3 wt. % or more, about 0.4 wt. % or more, about 5 wt. % or more. Based on the total weight of the coating composition, the amount of the modified polycarbodiimide compound may be about 5 wt. % or less, about 4 wt. % or less, about 3 wt. % or less. For example, based on the total weight of the coating composition, the amount of the modified polycarbodiimide compound may be about 0.8 wt. %, 1 wt. %, 1.2 wt. %, 1.5 wt. %, 1.8 wt. %, 2 wt. % or 2.5 wt. %. In some embodiments, the amount of the modified polycarbodiimide compound may be from about 0.5 wt. % to 2.0 wt. %, or from about 1 wt. % to 1.5 wt. %. By using the modified polycarbodiimide compound with the about amounts, excellent coating properties, such as excellent combination of curing effect and resistance, can be obtained at the same time.

In this disclosure, film-forming resin refers to a resin that can form a film when the coating is cured. Various types of film-forming resins can be used. Examples of common film-forming resins include self-crosslinking resin, polyurethane resin, polyurethane acrylate resin, alkyd resin, acrylic resin, isocyanate resin, polyurethane acrylate modified epoxy resin, unsaturated polyester resin, acrylated epoxy resin, nitro resin, or combinations thereof. In some embodiments, the film-forming resin comprises one or more of self-crosslinking resin, polyurethane resin, polyurethane acrylate resin, alkyd resin and acrylic resin. In one embodiment, the film-forming resin comprises one or more of self-crosslinking resin, polyurethane resin and polyurethane acrylate resin.

In some embodiments, the film-forming resin comprises a self-crosslinking resin. Self-crosslinking resin refers to a resin that can be crosslinked without adding crosslinking agent. Examples of a self-crosslinking resin include self-crosslinking polyester resins, self-crosslinking polyamide resins, self-crosslinking acrylic resins, self-crosslinking epoxy resins, self-crosslinking olefin resins, or combinations thereof. In one embodiment, the self-crosslinking resin comprises a self-crosslinking acrylic resin. In an exemplary embodiment, the self-crosslinking resin comprises an acrylic siloxane resin.

Self-crosslinking resins can be obtained from monomers with self-crosslinking groups. For example, self-crosslinking acrylic resins can be prepared from functional monomers containing a ketone carbonyl or epoxy group and hydrazide compounds. Examples of the functional monomers containing a ketone carbonyl or epoxy group may comprise, for example, diacetone acrylamide (DAAM), methyl vinyl ketone, ethyl acetoacetate methacrylate (AAEM), glycidyl methacrylate (GMA), acetamidoethyl (meth)acrylate, etc. In some embodiments, the functional monomer containing a ketone carbonyl group comprises one or more of DAAM, AAEM and GMA. In one embodiment, the functional monomer containing a ketone carbonyl group comprises DAAM, AAEM or a combination of the two.

Due to low toxicity and simple raw materials for synthesis and its benefit to enhancing the adhesion of coatings, DAAM is mostly used as a functional monomer containing ketone carbonyl group. In an exemplary embodiment, the functional monomer containing ketone carbonyl group comprises DAAM. In another exemplary embodiment, the functional monomer containing ketone carbonyl group comprises AAEM.

Examples of hydrazide compounds may include, for example, adipic dihydrazide (ADH), succinic dihydrazide, carbohydrazide, oxalylhydrazide, N(CH₂CH₂CONHNH₂)₃ and (H₂NHNCOCH₂CH₂)₂NCH₂CH₂N(CHCHCONHNH₂)₂, and polymeric polyhydrazides.

Self-crosslinking acrylic resin may be obtained by synthetic method. For example, self-a crosslinking polyacrylate emulsion (PAE) with seal function may be synthesized by semi continuous seeded emulsion polymerization using diacetone acrylamide (DAAM), methyl methacrylate (MMA), butyl acrylate (BA) and methacrylic acid (MAA) as co-monomers.

Self-crosslinking acrylic resin may be commercially available, for example, as self-crosslinking acrylic emulsion. Examples of commercially available self-crosslinking acrylic emulsion include, but are not limited to, ROSHIELD™ 3311 and ROSHIELD™ 3188.

In some embodiments, the film-forming resin comprises at least one polyurethane resin. Various types of polyurethane resins may be used. The polyurethane resin may be in the form of polyurethane dispersion (PUD). For example, U Series (such as U 6150, U 9380 and U 9900) commercially available from Alberdingk Boley, Inc., Bayhydrol series (such as Bayhydrol® UH 2558 and Bayhydrol® UH 2606) and Dispercoll series commercially available from Bayer, NeoRez series (such as NeoRez® R-2180, NeoRez® R-2005, NeoRez® R-9029 and NeoRez® R-2190) commercially available from DSM, SYNTEGRA series commercially available from Dow or Sancure series (such as Sancure 843, Sancure 898 and Sancure 12929) commercially available from Lubrizol, Inc. (Cleveland, OH) may be used.

In some embodiments, the film-forming resin comprises at least one polyurethane acrylate (PUA) resin. Various types of polyurethane acrylate resins may be used. For example, Hybridur series (such as Hybridur 870 and Hybridur 878) commercially available from Air Products, Inc., APU series (APU 10140, APU 10600 and APU 10620) commercially available from Alberdingk Boley, Inc., NeoPac® series (NeoPac R-9036 and NeoPac E-129) commercially available from DSM, CONFON 7005 commercially available from Confon Chemical Technology Co., Ltd., or PROSPERSE™ 100 commercially available from DOW may be used.

In some embodiments, the film-forming resin has at least one side chain comprising ketone carbonyl (—(C═O)—), epoxy group, or combinations thereof. In one embodiment, the side chain of the polymer comprises a ketone carbonyl group.

Based on the total weight of the coating composition, the amount of film-forming resin may be about 45-95 wt. %, about 50-90 wt. %, about 60-85 wt. %, and about 65-80 wt. %.

In the coating composition, the at least one co-solvent may be an organic solvent commonly used in the art. For example, the co-solvent may be one or at least two of alkyl alcohols, alcohol ethers, ketones or esters. Examples of co-solvent include, but are not limited to, ethanol, isopropanol, butanol, butoxydiglycol, butyl glycol, dipropylene glycol methyl ether (DPM), propylene glycol methyl ether, ethylene glycol butyl ether, dipropylene glycol butyl ether (DPnB), ethylene glycol ethyl ether, ethylene glycol monomethyl ether, ethylene glycol monohexyl ether, ethylene glycol monon-butyl ether, diethylene glycol monomethyl ether, diethylene glycol monon-butyl ether tripropylene glycol monomethyl ether, ethylene alcohol monoisobutyl ether, diethylene glycol monoisobutyl ether, propylene glycol monoisobutyl ether, ethylene glycol monophenyl ether, propylene glycol monophenyl ether, ethylene glycol monomethyl ether acetate, acetone, methyl ethyl ketone, methyl isobutyl ketone, cyclohexanone, toluene, xylene, trimethylbenzene, solvent naphtha-100, 2-methylpropyl acetate and n-butyl acetate, or any combination thereof.

Based on the total weight of the coating composition, the amount of at least one co-solvent may be about 4-10 wt. %, about 5-9 wt. %, or about 6-8 wt. %. For example, the amount of at least one co-solvent can be about 6.5 wt. %, 7 wt. %, 7.5 wt. % or 8 wt. %, based on the total weight of the coating composition.

In some embodiments, based on the total weight of the coating composition, the amount of water may be about 5-40 wt. %, about 8-35 wt. %, or about 10-30 wt. %. For example, based on the total weight of the coating composition, the amount of water may be about 12, 13, 14, 15, 16, 18, 20, 22 or 25 wt. %.

The coating composition of the application can also optionally contain at least one other additives. Other additives may be those commonly used in coating compositions. Those additives do not adversely affect the coating composition or a cured coating resulting therefrom. Suitable additives include those agents which can, for example, improve the manufacturing, processing of the composition, enhance composition esthetics, improve a particular functional property or characteristics (for example, the adhesion to a substrate) of a coating composition or a cured coating resulting therefrom. Depending on the particular needs, the additives that may be contained in the coating composition include, but not limited to at least one pigment, filler, anti-skinning agent, drier, emulsifier, anti-migration aid, antibacterial agent, chain extender, lubricant, wetting agent, biocide, plasticizer, defoamer, colorant, wax, antioxidant, anticorrosive agent, anti-freezing agent, rheological aid, thickener, dispersant, adhesion promoter, UV stabilizer, pH adjuster, leveling agent, or combinations thereof. The amount of each of optional ingredients is sufficient to achieve its intended purpose, but such amount does not adversely affect the coating composition or the cured coating derived therefrom.

In some embodiments, the at least one pigment may be in shape of sphere, fiber, flake, or other regular or irregular shapes of micrometric or even nanometric size. Suitable examples of pigments include metal oxides such as titanium dioxide, iron oxides, zinc oxide, zirconia, or aluminia; metal composite oxides containing two or more metal elements including manganese, nickel, titanium, chromium, antimony, magnesium, cobalt, iron, or aluminum; oxymetallic compounds, such as bismuth vanadate, cobalt aluminate, cobalt zincate, or zinc chromate; metallic pigments, such as aluminum flake, copper, and copper-zinc alloys; and pearlescent pigments, such as lead carbonate and bismuth oxychloride; talc; and any combinations thereof. In one embodiment, the pigment is titanium dioxide, including but not limited to titanium dioxide in powder form. In one embodiment, the pigment comprises rutile titanium dioxide. All of these types of thickeners are commercially available. For example, titanium dioxide pigment BLR-688 available from Billions may be used as an example of the pigment.

The total amount of the at least one pigment may be from 0 wt. % to 50 wt. %, for example, from 1 wt. % to 45 wt. %, from 2 wt. % to 40 wt. %, from 3 wt. % to 35 wt. %, from 4 wt. % to 30 wt. %, from 5 wt. % to 25 wt. %, from 10 wt. % to 20 wt. %, based on the total weight of the coating composition. Further in some embodiments, the amount of each pigment is independently of from 0 wt. % to 50 wt. %, from 1 wt. % to 40 wt. %, from 2 wt. % to 30 wt. %, from 3 wt. % to 20 weight. %, or from 4 wt. % to 15 wt. %, based on the total weight of the coating composition.

In other embodiments, other additives comprise one or more of defoamers, leveling agents, thickeners and wetting agents. As an example of the leveling agents, BYK 358 available from BYK may be used. As an example of the defoamers, BYK-071 available from BYK may be used.

In some embodiments, relative to the total weight of the coating composition, the coating composition comprises about 0 to about 30 wt. %, about 0.1 to about 25 wt. % of other additives. Specifically, relative to the total weight of the coating composition, the amount of each other additive in the coating composition may be 0.1 wt. % to 10.0 wt. %, such as 0.2 wt. %, 0.3 wt. %, 0.4 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.8 wt. %, 2.0 wt. %, 2.5 wt. % 3.0 wt. %, 3.5 wt. %, 4.0 wt. %, 4.5 wt. %, 5.0 wt. %, 6.0 wt. %, 8.0 wt. %, or 9.0 wt. %.

Suitable thickeners include one or more of cellulose thickener, alkali swelling thickeners, polyurethane thickeners, hydrophobically modified polyurethane thickeners and inorganic thickeners. All of these types of thickeners are commercially available products. For example, as an example of cellulose thickener, hydroxyethyl cellulose thickener HEC 250 H4BR commercially available from ASHLAND Company, USA, may be used. As an example of alkali swelling thickener, ASE60 commercially available from Dow Chemical Co., USA may be used. RM-2050D commercially available from Dow Chemical Co., USA, U902 or U903 commercially available from Wanhua Chemical Group may be used as examples of polyurethane thickener. As an example of an inorganic thickener, bentonite can be used.

In some embodiments, the coating composition described herein may comprise about 0.1 wt. % to about 5.0 wt. %, about 0.5 wt. % to about 4.0 wt. %, or 1.0 wt. % to 3.0 wt. % of at least one thickener, relative to the total weight of the coating composition. For example, the coating composition comprises 1.2 wt. %, 1.5 wt. %, 2.0 wt. % or 2.5 wt. % of at least one thickener, relative to the total weight of the coating composition.

The coating composition of the present application may optionally comprise at least one defoamer. Suitable defoamers may include one or more of organic siloxane defoamers, oil defoamers, polyether defoamers, and polyether-modified organic silicone defoamers. For example, non-ionic mineral oil may be used. All of these types of defoamers are commercially available products. As an example of defoamers, CF-246 commercially available from Blackburn Chemicals can be used.

In some embodiments, the coating composition may comprise about 0 wt. % to about 1.0 wt. %, or about 0.3 wt. % to about 0.5 wt. % of at least one defoamer, relative to the total weight of the coating composition.

In some embodiments, based on the total weight of the coating composition, the coating composition comprises:
50-90 wt. % of the at least one film-forming resin;
4-10 wt. % of the at least one co-solvent;
5-40 wt. % of water; and
0.3-5 wt. % of the at least one modified polycarbodiimide compound.

Further, based on the total weight of the coating composition, the coating composition may further comprise 0-1 wt. % of other additive(s). The other additive(s) may include one or more of defoamer, leveling agent, thickener and wetting agent. Other additives are also contemplated.

In some embodiments, component B) may also comprise at least one crosslinking agent other than the modified polycarbodiimide compound described herein. The inventors have found that the use of other crosslinking agents can stabilize the improvement of resistance of film, or even further improve the resistance of the film.

In the coating composition described herein, other crosslinking agents may be free of or substantially be free of sensitizing substances (such as aziridine and the like).

Other crosslinking agents may comprise a compound having at least one —N═C═N— or at least one epoxy functional group. In some embodiments, other crosslinking agents comprise at least one carbodiimide compound other than the modified polycarbodiimide compound described herein, at least one silane compound, or a combination thereof.

The above carbodiimide compound has at least one —N═C═N—. As the carbodiimide-group-containing compound, a polycarbodiimide compound containing at least two carbodiimide groups per molecule or carbodiimide-derived moieties may be used. In some embodiments, the carbodiimide compound has at least three carbodiimide groups per molecule. For example, in some exemplary embodiments, the carbodiimide compound has 3 to 7 carbodiimide groups. The carbodiimide compound may include aliphatic carbodiimide compounds, alicyclic carbodiimide compounds, or aromatic carbodiimide compounds.

In many embodiments, the carbodiimide compound are water-soluble or water-dispersible. There is no particular limitation to the water-soluble or water-dispersible polycarbodiimide compounds so long as the polycarbodiimide compounds are stably dissolved or dispersed in an aqueous medium. Examples of the water-soluble or water-dispersible polycarbodiimide compounds include CARBODILITE SV-02, CARBODILITE V-02, CARBODILITE V-02-L2, CARBODILITE V-04, CARBODILITE E-01, CARBODILITE E-02 and CARBODILITE E-05 (names of products commercially available from Nisshinbo Industries, Inc.), and the like. Such polycarbodiimide compounds can be used singly or in a combination of two or more.

Carbodiimide compounds may also be synthesized by common well-known methods. For example, carbodiimide compounds may also be synthesized by decarboxylation condensation of various polyisocyanates at a temperature above about 70° C. in a solvent-free or inert solvent using organophosphorus compounds or organometallic compounds as catalysts.

Silane compound may be used as crosslinking agents. In some embodiments, the silane compound is an epoxy silane compound. The epoxy silane compound may have an epoxy equivalent in the range of 4 to 6 meq/g.

In some embodiments, the epoxy silane compound is an epoxy silane oligomer of the following Formula (I)

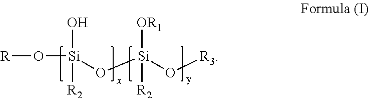

In Formula (I), R and R₁ are independently substituted or unsubstituted alkyl groups; R₂ is independently a substituted or unsubstituted linear, branched or cyclic alkyl or an alkyl ether residue substituted by an epoxide; R₃ is hydrogen or substituted or unsubstituted alkyl, and x+y≥2, x≥0.

In Formula (I), R and R₁ are independently C₁₋₁₀ alkyl (such as, linear or branched C₁₋₁₀ alkyl), including an alkyl substituted with aryl (i.e., an arylalkyl). For example, R and R₁ are independently methyl or ethyl. In some embodiments, R and R₁ are independently substituted or unsubstituted arylalkyl groups having at least 7 carbon atoms, such as substituted or unsubstituted benzyl groups.

R₂ is an alkyl ether residue substituted with epoxide, or a substituted or unsubstituted linear, branched or cyclic alkyl group with less than or equal to 30 carbon atoms.

R₃ is hydrogen or a substituted or unsubstituted alkyl (linear or branched, including cycloalkyl) or unsubstituted arylalkyl.

The sum of x and y is at least 3.

For example, useful epoxy silane compounds have the following structures:

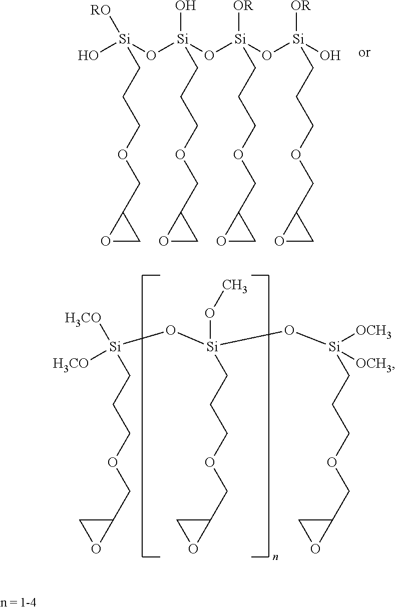

in which, R is C₁₋₁₀alkyl (e.g., linear or branched), including an alkyl substituted with aryl (i.e., arylalkyl). For example, R is independently methyl or ethyl.

Exemplary epoxy silane compounds include, for example, commercially available CoatOSil MP 200.

The amount of other crosslinking agent can be appropriately adjusted according to the type of other crosslinking agent, film-forming resin and desired film properties. Based on the total weight of the coating composition, the amount of other crosslinking agent may be about 0.3 wt. % to 8 wt. %, about 0.5 wt. % to 6 wt. %, or about 1 wt. % to 5 wt. %. For example, based on the total weight of the coating composition, the amount of crosslinking agent may be about 1.2 wt. %, about 2 wt. %, about 3 wt. %, or about 4 wt. %.

The preparation of the coating composition described herein can be accomplished by any appropriate mixing method well known to those skilled in the art. For example, the coating composition can be made by the follows step of: adding at least one film-forming resin or emulsion, at least one co-solvent, at least one crosslinking agent and optional additives to the container, then stirring the mixture to until homogeneous. Alternatively, the coating composition may be made by first mixing the at least one crosslinking agent with at least one co-solvent and then adding at least one film-forming resin or emulsion and the optional additives to form a homogeneous mixture. Water may be added during the preparation of the coating composition.

The aqueous coating composition may be applied by conventional methods known to those skilled in the art. In some embodiments, the coating composition is applied by brushing, spraying and other coating methods known in the art. In this way, a coating can be formed from the coating composition of the present application, and the resulting coating also falls within the protection scope of the present application. Thus, the present application also provides a coating that can be obtained from the coating composition described herein.

The coating composition described herein is suitable for use in applications such as wood, metal, plastic, inner, outer wall and cement board. It is particularly suitable for use as a wood coating composition.

A third aspect of the present application provides a coated article, comprising a substrate; and a coating composition or a cured coating formed by the coating composition as described herein, coated on the substrate.

Examples of substrate may be selected from one or more of wood, metal, plastic, inner wall, outer wall and cement board. Examples of suitable substrate materials include wood, cement, cement fiber board, wood-plastic composites, tile, metal, plastic, glass, and fiberglass. In many embodiments, the coating composition is particularly suitable for use on wood substrates. Suitable wood substrates include substrates derived from wood materials such as oak (e.g., white oak and red oak), pine (e.g., white pine and southern yellow pine), poplar, spruce, cherry, walnut, redwood, cedar, maple, mahogany, birch, hickory, walnut, ash, and the like. In some embodiments, wood materials for the wood substrate include those that exhibit light colors and are susceptible to UV-light discolorations, such as oak, pine, maple, and the like. In addition, the wood substrate may be an engineered wood product, in which the substrate is prepared from wood pieces (e.g., sheets, chips, flakes, fibers, strands).

Unless otherwise specified, the various features described herein and the corresponding methods can be combined.

### EXAMPLES

The present application is more particularly described in the following examples that are intended as illustrations only. Embodiments are not limited to these specific examples. Unless otherwise noted, all parts, percentages, and ratios reported in the following examples are on a weight basis. In addition, all reagents used in the examples are commercially available and used directly without further treatment. For example, in the following examples, CARBODILITE E-05 is a commercially available PCDI as a raw material. Those skilled in the art can easily purchase or prepare the raw materials used in the embodiment.

Test Methods

Chemical resistance (or liquid resistance): the resistance of a film to Na₂CO₃, acetic acid, water and hot water was measured by using the corresponding test time according to GB/T 4893.1. The results were evaluated according to the grading standard, in which 5=the best and 0=the worst.

Infrared spectrum (FT-IR): an attenuated total reflection (ATR) test was performed on a sample by using Thermo Nicolet Nexus 470-FTIR infrared spectrometer, the United States.

Differential scanning calorimetry (DSC): sample was tested by using TA DSC Q2000 differential scanning calorimeter with the temperature range of from −50° C. to 150° C. and the programmed temperature rise rate of 20° C./min.

### Example 1: Preparation and Characterization of Modified Polycarbodiimide Compounds

Benzotriazole was dissolved in dipropylene glycol methyl ether (DPM) and dipropylene glycol butyl ether (DPNB) at the weight percentages of materials as shown in Table 1. Then the mixture was added to commercially available CARBODILITE E-05 (solid content of 40%) under stirring at room temperature. After reaction, the modified polycarbodiimide compounds (represented by PCDI #) were obtained, including PCDI #-A (modified with 1.5% benzotriazole), PCDI #-B (modified with 2% benzotriazole), PCDI #-C (modified with 4.5% benzotriazole) and PCDI #-D (modified with 6% benzotriazole).

As a control, benzotriazole was not added to PCDI sample.

The weight percentages in Table 1 were based on the total weight (i.e. 100 g) of materials (including DPM, DPNB, benzotriazole and PCDI).

TABLE 1
Preparation and characterization of PCDI#

| Sample | | PCDI | PCDI#-A | PCDI#-B | PCDI#-C | PCDI#-D |
|---|---|---|---|---|---|---|
| Materials | DPM | — | 1.50% | 3% | 4% | 4.50% |
| | DPnB | — | 1% | 2% | 2.50% | 2.50% |
| | Benzotriazole | — | 1.50% | 2% | 4.50% | 6% |
| | CARBODILITE E-05 | 100% | 96% | 93% | 89% | 87% |
| Properties of | Mn(g/mol) | 1882 | 1953 | 2084 | 2213 | 2386 |
| products | Effective molar ratio | 100/0 | 100/12 | 100/16 | 100/49 | 100/82 |
| | 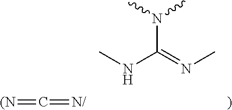 | | | | | |

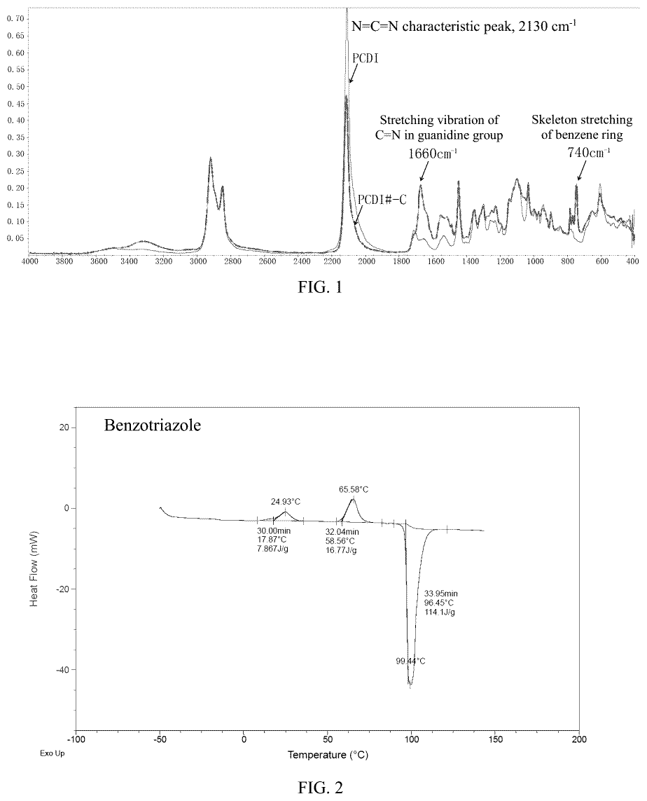

The control sample PCDI and sample PCDI #-C were analyzed by IR and DSC respectively. The results were shown in FIGS. 1 and 2-3.

FIG. 1 shows a comparison of PCDI with PCDI #-C in infrared absorption spectra, wherein the peaks of methyl group are used as reference basis. In the FT-IR figure, on the premise of consistent methyl peak intensity, the intensity of characteristic peak of N═C═N of PCDI #-C at about 2130 cm⁻¹ decreased, indicating that some of N═C═N groups decreased due to the reaction with benzotriazole. Moreover, compared with PCDI, PCDI #-C has an obvious intensity enhancement of peak at about 1660 cm⁻¹ (the absorption peak of stretching vibration of C═N in guanidine group) and an obvious peak at 740 cm⁻¹ of skeleton stretching of benzene ring.

FIG. 2 shows the DSC curve of benzotriazole. It can be seen that benzotriazole has an obvious melting peak at about 99° C.

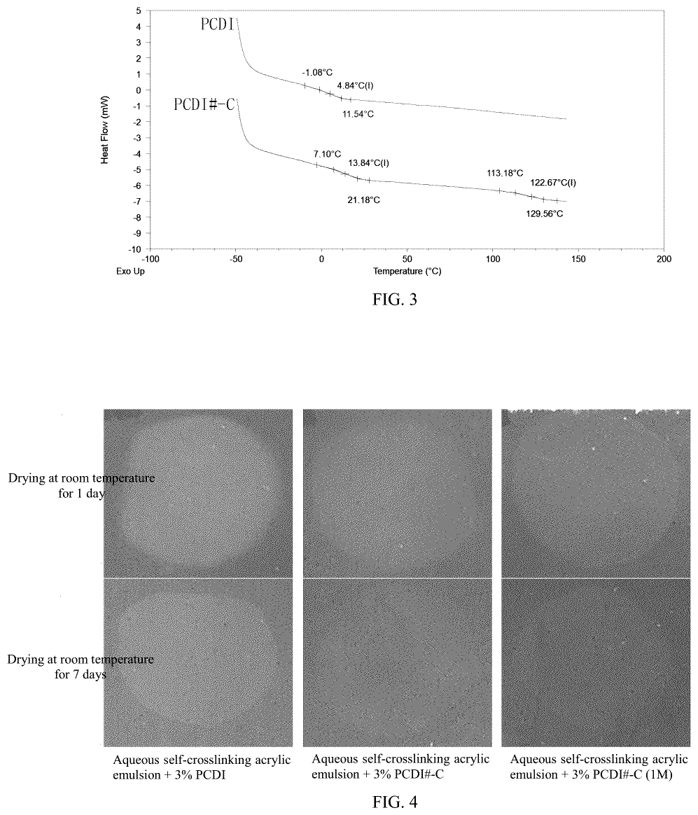

FIG. 3 shows the DSC curves of PCDI and PCDI #-C. It can be seen from FIG. 3 that the modified PCDI #-C does not have the melting peak of benzotriazole, so it does not contain residual benzotriazole compound. Moreover, the glass transition temperature (Tg) (13.84° C.) of PCDI #-C as measured by DSC is significantly higher than that of PCDI (4.84° C.), and a new Tg (122.67° C.) appeared.

Combined with the infrared spectra, it can be confirmed that in PCDI #-C, benzotriazole completely reacts with PCDI, and the modified PCDI #-C not only has the same characteristic peak N═C═N structure as PCDI, but also has the characteristic peak of benzene ring in benzotriazole.

### Example 2: Formulation of Coating Composition and Performance of Coating

Commercially purchased emulsions or dispersions as specifically shown in Table 2 were used, including aqueous acrylic emulsion (such as Wanhua 4401), aqueous self-crosslinking acrylic emulsion (such as ROSHIELD™ 3311), aqueous polyurethane modified acrylic emulsion (such as E-129), aqueous polyurethane dispersion (example R-2180).

The components were mixed in the amounts shown in Table 2 to obtain the coating compositions. Based on the total weight of the emulsions or dispersions, 75 wt. % of film-forming resin, 3 wt. % of DPM, 3.5 wt. % of DPnB, 1.7 wt. % of defoamer, 0.3 wt. % of leveling agent, 0.6 wt. % of thickener, and 0.1 wt. % of rheological aid were contained in the emulsions or dispersions. The weight percentages in Table 2 were based on the total weight of the coating compositions.

Each of the coating compositions was applied on wood. After the surface was touch dry, the sample was baked at 40° C. for 2 hours, and then dried at room temperature for 7 days. The properties of the resulting films were tested. The results were shown in Table 2.

TABLE 2
Coating compositions and properties of films

| | | Chemical resistance | | | |
|---|---|---|---|---|---|
| | Crosslinking | 10% Na₂CO₃ | 10% acetic acid | Water | Hot water |
| Emulsion or dispersion | agent | (24 h) | (24 h) | (24 h) | (20 min) |
| Aqueous self-crosslinking acrylic | 3% PCDI | 3.5 | 3 | 2 | 3 |
| emulsion | 3% PCDI#-C | 4 | 4 | 3.5 | 3.5 |
| Aqueous acrylic emulsion + aqueous | 3% PCDI | 3.5 | 2.5 | 3 | 3.5 |
| polyurethane modified acrylic emulsion | 3% PCDI#-C | 4 | 3.5 | 4.5 | 4.5 |
| Aqueous acrylic emulsion + aqueous | 3% PCDI | 4 | 3.5 | 2.5 | 3.5 |
| polyurethane dispersion | 3% PCDI#-C | 4 | 4 | 4 | 4.5 |
| | 3% PCDI | 3.5 | 3 | 2.5 | 3 |
| Aqueous self-crosslinking acrylic | 3% PCDI#-C | 4 | 4 | 4 | 4 |
| emulsion + aqueous polyurethane | | | | | |
| modified acrylic emulsion | | | | | |
| Aqueous self-crosslinking acrylic | 3% PCDI | 3.5 | 3 | 3 | 3.5 |
| emulsion + aqueous polyurethane | 3% PCDI#-C | 4 | 4 | 4.5 | 4.5 |
| dispersion | | | | | |
| Aqueous acrylic emulsion + aqueous | 3% PCDI | 4 | 3.5 | 3 | 3 |
| polyurethane modified acrylic emulsion + | 3% PCDI#-C | 4.5 | 4.5 | 4.5 | 4.5 |
| aqueous polyurethane dispersion | | | | | |

It can be seen that the modified polycarbodiimide compound of the present application is applicable to various coating systems of emulsion or dispersion, and can improve the chemical resistance of the coating, in particular, significantly improve water resistance.

In order to determine the high temperature stability of the modified polycarbodiimide compound, the PCDI #-C used in example 2 was placed in an oven at 50° C. for one month (represented by PCDI #-C (1m)), and then PCDI #-C (1m) was compared in parallel with the unmodified commercial PCDI and PCDI #-C without 50° C. heat storage. In particular, under the conditions with other same parameters, two-component coatings were prepared with PCDI #-C (1m), PCDI and PCDI #-C, respectively. Each of the coatings was applied on wood. After the surface was touch dry, the sample was baked at 40° C. for 2 hours, and then dried at room temperature for 1 day or 7 days. The water resistance of the resulting film was tested. The results of water resistance were shown in Table 4.

In FIG. 4, the photos in the first column show water resistance results of the films prepared with unmodified commercial PCDI after drying for 1 day or 7 days, respectively. The photos in the second column show water resistance results of the films prepared by benzotriazole modified PCDI #-C. The photos in the third column show water resistance results of the films prepared by benzotriazole modified PCDI #-C after one-month heat storage.

It can be seen from the results in FIG. 4 that although PCDI #-C (1m) had been stored in an oven at 50° C. for one month, the prepared film still showed stable and excellent water resistance (the whitening appearance of the paint film was equivalent to that of PCDI #-C). The film obtained by unmodified commercial PCDI was obviously whitened after drying at room temperature for 1 or 7 days. So the benzotriazole modified PCDI # can still improve the water resistance of the film after one-month heat storage, thus it has excellent thermal stability.

### Example 3: Using Different Crosslinking Agents

In order to compare the properties caused by using different crosslinking agents, CoatOSil MP 200 epoxy silane compound and DSM CX100 multifunctional aziridine were used as crosslinking agents, respectively. Since mp200 and Cx100 had the solid content of 100%, they were used in amount of 1.2% for comparison.

TABLE 3
Coating compositions with different crosslinking agents
and properties of films

| | | Chemical resistance | | | |
|---|---|---|---|---|---|
| | | 10% | 10% acetic | | |
| | Crosslinking | Na₂CO₃ | acid | Water | Hot water |
| Emulsion | agent | (24 h) | (24 h) | (24 h) | (20 min) |
| Aqueous self- | 3% PCDI | 3.5 | 3 | 2 | 3 |
| crosslinking | 3% PCDI#-C | 4 | 4 | 3.5 | 3.5 |
| acrylic | 1.2% MP200 | 4 | 4 | 3.5 | 3.5 |
| emulsion | 1.2% CX100 | 4 | 4.5 | 4 | 4 |

It can be seen from table 3 that chemical resistance obtained by using modified PCDI # is significantly better than that of PCDI, even equivalent to that of epoxy silane compound, close to that of multifunctional aziridine. By such “simple” modification of polycarbodiimide compound, the crosslinking density and chemical resistance of the resultant film can be greatly improved.

Moreover, it is worth noting that the PCDI # in the present application has no sensitization and thus avoids the sensitization problem of aziridine. The technical solution in the present application is simple, low cost and safer.

### Example 4: Effects of Different Degree of Modification on Film Performance

The relative content of —N═C═N— structural unit and

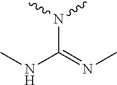

structural unit in the modified PCDI # was adjusted by adding different amounts of benzotriazole. The obtained films were tested for chemical resistance. The results were shown in Table 4 below.

TABLE 4

| | | Chemical resistance | | | |
|---|---|---|---|---|---|
| | Crosslinking | 10% Na₂CO₃ | 10% acetic acid | Water | Hot water |
| Emulsion | agent | (24 h) | (24 h) | (24 h) | (20 min) |
| Aqueous acrylic emulsion + | 3% PCDI | 3.5 | 2.5 | 3 | 3.5 |
| aqueous polyurethane | 3% PCDI#-A | 3.5 | 3 | 3.5 | 3.5 |
| modified acrylic emulsion | 3% PCDI#-B | 4 | 3.5 | 4.5 | 4.5 |
| | 3% PCDI#-C | 4 | 3.5 | 4.5 | 4.5 |
| | 3% PCDI#-D | 3.5 | 3 | 3 | 3.5 |

It can be seen from Table 4 that chemical resistance of the obtained films was further improved by using PCDI #-B and PCDI #-C. Therefore, by adjusting the relative content of —N═C═N— structural unit and

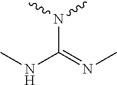

structural unit in the modified PCDI # to control the degree of modification, the chemical resistance of the film can be further optimized.

### Example 5: Effects of Different Modifiers Used for Modification of PCDI on Film Performance

Different compounds were used for the preparation of modified PCDI. The amounts “4.5%” of crosslinking agent shown in Table 5 were based on the total weight of materials (including DPM, DPNB, modifiers and PCDI) used for the preparation of modified PCDI #. Then, the coating compositions were prepared using the same method and amount as in Example 2 (using 3 wt. % of crosslinking agents based on the total weight of the coating composition).

The obtained films were tested for chemical resistance. The results were shown in Table 5 below.

TABLE 5

| | | Chemical resistance | | | |
|---|---|---|---|---|---|
| | | 10% Na₂CO₃ | 10% acetic acid | Water | Hot water |
| Emulsion | Crosslinking agent | (24 h) | (24 h) | (24 h) | (20 min) |
| Aqueous acrylic | PCDI | 3.5 | 2.5 | 3 | 3.5 |
| emulsion + aqueous | PCDI#-C, modified with | 4 | 3.5 | 4.5 | 4.5 |
| polyurethane | 4.5% benzotriazole | | | | |
| modified acrylic | PCDI#-E, modified with | 4 | 3 | 3.5 | 4 |
| emulsion | 4.5% indole | | | | |
| | PCDI#-F, modified with | 4 | 3.5 | 4 | 4 |
| | 4.5% benzimidazole | | | | |
| | PCDI#-G, modified with | 4 | 3.5 | 4 | 4 |
| | 4.5% 2-phenylimidazole | | | | |
| | PCDI#-H, modified with | 3 | 2 | 2 | 3 |
| | 4.5% 1,2,4-triazole | | | | |
| | PCDI#-I, modified with | 3.5 | 2.5 | 2.5 | 3 |
| | 4.5% 3,5-dimethylpyrazole | | | | |

The results showed that benzotriazole, benzimidazole, 2-phenylimidazole and indole can improve the resistance of films, compared with unmodified PCDI. In particular, benzotriazole, benzimidazole and 2-phenylimidazole significantly improve water and acid resistance of the films. In the results in Table 5, the film obtained by PCDI #-C modified with benzotriazole shows the optimal chemical resistance.

Some exemplary embodiments of the present invention are provided as follows:

Embodiment 1: A modified polycarbodiimide compound, comprising a polymer backbone containing at least one —N═C═N— structural unit and at least one

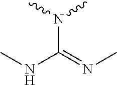

structural unit, wherein the

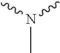

represents aza-heterocyclic ring attached to the polymer backbone, and the aza-heterocyclic ring is fused or chemically bonded with optionally substituted or optionally aza-benzene ring.

Embodiment 2: An embodiment of Embodiment 1, wherein molar ratio of the at least one —N═C═N— structural unit and the at least one

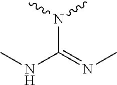

structural unit in the polymer backbone is in the range of from 100:80 to 100:10.

Embodiment 3: An embodiment of Embodiment 1, wherein the modified polycarbodiimide compound has a number average molecular weight of from 1500 to 5000 g/mol.

Embodiment 4: An embodiment of any of Embodiments 1-3, prepared by reacting at least one polycarbodiimide compound with at least one fused aza-heterocyclic compound or at least one aza-heterocyclic compound substituted with at least one aromatic group, wherein the at least one fused aza-heterocyclic compound or the at least one aza-heterocyclic compound substituted with at least one aromatic group has a ring containing at least one —NH— bond.

Embodiment 5: An embodiment of Embodiment 4, wherein the at least one fused aza-heterocyclic compound or the at least one aza-heterocyclic compound substituted with at least one aromatic group has a structure with five-membered aza-heterocyclic ring.

Embodiment 6: An embodiment of Embodiment 5, wherein the five-membered aza-heterocyclic ring is fused or chemically bonded with at least one benzene ring.

Embodiment 7: An embodiment of any of Embodiments 4 to 6, wherein the at least one fused aza-heterocyclic compound comprises one or more of benzotriazole, benzimidazole, indole, purine and phthalimide.

Embodiment 8: An embodiment of any of Embodiments 4 to 7, wherein the at least one aza-heterocyclic compound substituted with at least one aromatic group comprises one or more of 2-phenylimidazole and 2-phenyl-4-methylimidazole.

Embodiment 9: A coating composition, comprising: component A) comprising at least one film-forming resin, at least one co-solvent and at least one optional additive; and component B) comprising at least one crosslinking agent, wherein the at least one crosslinking agent comprises the modified polycarbodiimide compound according to any one of Embodiments 1 to 8.

Embodiment 10: An embodiment of Embodiment 9, wherein the film-forming resin comprises one or any combination of self-crosslinking resin, polyurethane resin, polyurethane acrylate resin, alkyd resin, acrylic resin, isocyanate resin, polyurethane acrylate modified epoxy resin, unsaturated polyester resin, acrylated epoxy resin and nitro resin.

Embodiment 11: An embodiment of Embodiment 9, wherein based on the total weight of the coating composition, the modified polycarbodiimide compound has an amount of from 0.3 to 5 wt. %.

Embodiment 12: An embodiment of any of Embodiments 9 to 11, wherein based on the total weight of the coating composition, the component A) comprises: 50-90 wt. % of the at least one film-forming resin; 4-10 wt. % of the at least one co-solvent; 5-40 wt. % of water; and 0-1 wt. % of the at least one additive, including one or more of defoamer, leveling agent, thickener and wetting agent.

Embodiment 13: An embodiment of any of Embodiments 9 to 12, wherein the at least one crosslinking agent further comprises at least one polycarbodiimide compound other than the modified polycarbodiimide compound, a silane compound, or a combination thereof.

Embodiment 14: A coated article, comprising: a substrate comprising one or more of wood, metal, plastic, inner wall, outer wall and cement board; and a cured coating formed by the coating composition according to any one of Embodiments 9 to 13, coated on the substrate

While what has been described with respect to a number of embodiments and examples, those skilled in the art will appreciate that modifications may be made to the application without departing from the principles disclosed in the foregoing description. For example, without departing from the principles disclosed in the foregoing description, the technical solutions obtained by combining multiple features or implementations described herein shall be understood to belong to the contents recorded herein. Such modifications are to be considered as included within the following claims unless the claims expressly state otherwise. Accordingly, the embodiments described in detail herein are illustrative only and do not intend to limit the scope of what is described herein which is to be given the full breadth of the appended claims and any and all equivalents thereof.

What is claimed is:

1. A modified polycarbodiimide compound, comprising a polymer backbone containing at least one —N═C═N— structural unit and at least one 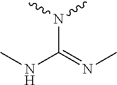
structural unit, wherein the 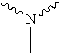
represents aza-heterocyclic ring attached to the polymer backbone, and the aza-heterocyclic ring is fused or chemically bonded with optionally substituted or optionally aza-benzene ring.

2. The modified polycarbodiimide compound according to claim 1, wherein molar ratio of the at least one —N═C═N— structural unit and the at least one 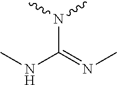
structural unit in the polymer backbone is in the range of from 100:80 to 100:10.

3. The modified polycarbodiimide compound according to claim 1, wherein the modified polycarbodiimide compound has a number average molecular weight of from 1500 to 5000 g/mol.

4. The modified polycarbodiimide compound according to claim 1, prepared by reacting at least one polycarbodiimide compound with at least one fused aza-heterocyclic compound or at least one aza-heterocyclic compound substituted with at least one aromatic group, wherein the at least one fused aza-heterocyclic compound or the at least one aza-heterocyclic compound substituted with at least one aromatic group has a ring containing at least one —NH— bond.

5. The modified polycarbodiimide compound according to claim 4, wherein the at least one fused aza-heterocyclic compound or the at least one aza-heterocyclic compound substituted with at least one aromatic group has a structure with five-membered aza-heterocyclic ring.

6. The modified polycarbodiimide compound according to claim 5, wherein the five-membered aza-heterocyclic ring is fused or chemically bonded with at least one benzene ring.

7. The modified polycarbodiimide compound according to claim 4, wherein the at least one fused aza-heterocyclic compound comprises one or more of benzotriazole, benzimidazole, indole, purine and phthalimide.

8. The modified polycarbodiimide compound according to claim 4, wherein the at least one aza-heterocyclic compound substituted with at least one aromatic group comprises one or more of 2-phenylimidazole and 2-phenyl-4-methylimidazole.

9. A coating composition, comprising:
component A) comprising at least one film-forming resin, at least one co-solvent and at least one optional additive; and
component B) comprising at least one crosslinking agent, wherein the at least one crosslinking agent comprises the modified polycarbodiimide compound according to claim 1.

10. The coating composition according to claim 9, wherein the film-forming resin comprises one or any combination of self-crosslinking resin, polyurethane resin, polyurethane acrylate resin, alkyd resin, acrylic resin, isocyanate resin, polyurethane acrylate modified epoxy resin, unsaturated polyester resin, acrylated epoxy resin and nitro resin.

11. The coating composition according to claim 9, wherein based on the total weight of the coating composition, the modified polycarbodiimide compound has an amount of from 0.3 to 5 wt. %.

12. The coating composition according to claim 9, wherein based on the total weight of the coating composition, the component A) comprises:
50-90 wt. % of the at least one film-forming resin;
4-10 wt. % of the at least one co-solvent;
5-40 wt. % of water; and
0-1 wt. % of the at least one additive, including one or more of defoamer, leveling agent, thickener and wetting agent.

13. The coating composition according to claim 9, wherein the at least one crosslinking agent further comprises at least one polycarbodiimide compound other than the modified polycarbodiimide compound, a silane compound, or a combination thereof.

14. A coated article, comprising:
a substrate comprising one or more of wood, metal, plastic, inner wall, outer wall and cement board; and
a cured coating formed by the coating composition according to claim 9, coated on the substrate.
